(19) United States
(12) Patent Application Publication
(10) Pub. No.: US 2004/0042947 A1
(43) Pub. Date: Mar. 4, 2004

(54) Method for NOx reduction

(76) Inventors: John Hoard, Livonia, MI (US); Christopher L. Aardahl, Richland, WA (US); Paul W. Park, Peoria, IL (US)

Correspondence Address: Douglas E. McKinley, Jr., McKinley Law Office, P.O. Box 202, Richland, WA, 99352, US

(21) Appl. No.: 10/648,885

(22) Filed: Aug. 26, 2003

Related U.S. Application Data
(60) Provisional application No. 60/407,149, filed on Aug. 28, 2002.

(51) Int. Cl. B01J 8/00; C01B 21/00

(52) U.S. Cl. 423/239.1; 423/239.2

(57) ABSTRACT

A method for reducing NOₓ in a gas stream by sequentially exposing the gas stream to a first and a second catalyst. The first catalyst converts at least a portion of the gas stream to a reducing gas, it reduces at least a portion of the NOₓ in a first temperature range, and it absorbs at least a portion of the NOₓ in the first temperature range. The second catalyst reduces at least a portion of the NOₓ in a second temperature range utilizing the reducing gas produced by the second catalyst. The reducing gas produced by the first catalyst is typically a partially oxidized hydrocarbon, preferably an aldehyde, and more preferably acetaldehyde or formaldehyde. In addition to the first and second catalysts, the gas stream may be exposed to a plasma. Preferably, the first catalyst is selected as a zeolite, and more preferably a zeolite impregnated with a cation. The cation is preferably selected from the group consisting of an alkaline cation, an alkaline earth cation, and combinations thereof and preferably exhibits pores sizes of greater than 4 angstroms, and more preferably exhibits pores sizes of greater than 7 angstroms. The second catalyst is preferably a γ-alumina catalyst, and more preferably a γ-alumina catalyst impregnated with transition metals, including, but not limited to, Ag, In and Sn.

### CROSS-REFERENCE TO RELATED APPLICATIONS

This application claims the benefit of, and priority to, Provisional U.S. Patent Application No. 60/407,149 filed Aug. 28, 2002 and entitled “Mixture of Heavy Duty and Light Duty Catalysts for NOₓ Control Using Plasma Assisted Catalysis” the entire contents of which are hereby incorporated herein by this reference.

### STATEMENT REGARDING FEDERALLY SPONSORED RESEARCH OR DEVELOPMENT

This invention was made with Government support under Contract DE-AC0676RLO1830 awarded by the U.S. Department of Energy. The Government has certain rights in the invention.

### BACKGROUND OF THE INVENTION

Diesel engines are attractive because their lean burn operation results in high fuel economy. The wear characteristics and ability to deliver power efficiently under high load conditions are also noteworthy advantages of diesel propulsion. Potential reduction in consumption of fossil fuels and reduction in greenhouse gas emissions could be achieved if greater diesel penetration were possible in the marketplace. However, advancement of diesel market share in future years will be limited unless engine emissions issues can be resolved. The high thermal efficiency of diesel engines is burdened with particulate matter (PM) and nitrogen oxides (NOx) emissions that exceed levels mandated by the United States Environmental Protection Agency (US EPA) starting in 2007 and phasing in completely by 2010 as set forth in the U.S. Environmental Protection Agency, Office of Transportation and Air Quality Regulatory Announcement: Heavy-Duty Engine and Vehicle Standards and Highway Diesel Fuel Sulfur Control Requirements, EPA420-F-00-057, December 2000 and C. Shenk, C. Laroo, SAE Technical Paper Series #2003-01-0042, SAE: Warrendale, Pa. 2003. The entire contents of these two papers, together with the entire contents of each and every other paper or presentation described and referenced herein as follows, are hereby incorporated into the disclosure of this patent application in their entirety.

Tier II limits for on road heavy duty vehicles will be imposed for commercial vehicles such as long haul trucks and city buses as well as light duty vehicles such as light trucks and smaller personal vehicles. It is expected that PM emissions will be addressed by the use of particulate filtration technology currently in advanced development as described in U.S. Environmental Protection Agency, Office of Transportation and Air Quality's paper “Heavy-Duty Standards/Diesel Fuel RIA—Chapter III: Ernission Standards Feasibility. EPA420-R-00-026, December 2000, but reduction of NOx emissions remains a difficult barrier. For example, any NOx reduction approach for on highway trucks must reduce emissions by 90-95% from 2002 levels to reach the 2010 target.

As a result of these and previous regulatory efforts, researchers have experimented with methods and devices seeking to reduce NOₓ emissions for years. The well known and universally sought after goal of reduced NOₓ emissions has provided an accepted benchmark of the success of these efforts, and those having skill in the art readily recognize that any technique that demonstrates an improvement over previously reported reductions NOₓ emissions sets the new standard for the state of the art.

For example, in the late 1980s, the concept of active lean NOx catalysis was introduced, where hydrocarbons are used as a reducing agent to assist NOx reduction to N₂ over a suitable catalyst, as described in W. Held and A. Koenig, German Offen. DE 3,642,018 (1987) and Y. Fujitani, H. Muraki, A. Nagoya, S. Kondoh, M. Fukui, and A. Toyoake, German Offen. DE 3,735,151 (1988). Since that time, promising NOx abatement technologies have been examined. For example, NOₓ-adsorber catalysis, so-called lean NOₓ traps (LNTs), is an advancement of the well established three-way catalyst technology used in gasoline-powered vehicles. Recent results show that sulfur-poisoned LNTs can be regenerated against sulfur poisoning using high temperature excursions that result in desulfation of the catalyst surface as described by J. Parks, B. Epling, A. Watson, and G. Campbell, in the “Durability of NOx Adsorbers” presentation given at the 8^{th} Diesel Engine Emissions Reduction Conference, US DOE FreedomCAR and Vehicle Technologies, San Diego, Calif. Aug. 25-29, 2002 and T. V. Johnson, SAE Technical Paper Series #2003-01-0039, SAE, Warrendale, Pa, 2003. As shown by S. Faulkner, in the “NOx Adsorber Development” presentation given at the 8^{th} Diesel Engine Emissions Reduction Conference, US DOE FreedomCAR and Vehicle Technologies, San Diego, Calif. Aug. 25-29, 2002, LNTs remain quite expensive for broad market acceptance due to high precious metal loading.

Another potential NOx emission control strategy is selective catalytic reduction (SCR) of NOx with urea. Certain bins in the EPA Tier II regulations for 2007 have been met with this approach as described by R. Hammerle in the “Urea Selective Catalytic Reduction and Diesel Particulate Filter System for Diesel Sport Utility Vehicle Meeting Tier II Bin 5” presentation given at the 8^{th} Diesel Engine Emissions Reduction Conference. US DOE FreedomCAR and Vehicle Technologies. San Diego, Calif. Aug. 25-29, 2002. However, the logistics of wide-scale distribution of urea is a significant concern for implementation in the time frame required.

Plasma-facilitated, lean NOx catalysis (PFC) using hydrocarbon reducing agents is another technology receiving limited attention for the reduction of NOx in light and heavy duty applications. Papers describing different aspects of this approach include, but are not limited to, J. Hoard and H. Servati (Eds.), Plasma Exhaust Aftertreatment, SAE SP-1395, SAE: Warrendale, Pa., 1998, M. L. Balmer, G. Fisher, and J. Hoard (Eds.), Non-Thermal Plasma for Exhaust Emission Control: NOx, HC, and Particulates, SAE SP-1483, SAE: Warrendale, Pa., 1999, M. L. Balmer, G. Fisher, and J. Hoard (Eds.), Non-Thermal Plasma, SAE SP-1566, SAE: Warrendale, Pa., 1998, M. L. Balmer, G. Fisher, and J. Hoard (Eds.), Non-Thermal Plasma Emission Control Systems, SAE SP-1639, SAE: Warrendale, Pa., 1998, S. Yoon, A. G. Panov, R. G. Tonkyn, A. C. Ebeling, S. E. Barlow, M. L. Balmer, Catal. Today 72 (2002) 243, S. Yoon, A. G. Panov, R. G. Tonkyn, A. C. Ebeling, S. E. Barlow, M. L. Balmer, Catal. Today 72 (2002) 251, L.-Q. Wang, C. L. Aardahl, K. G. Rappe, D. N. Tran, M. A. Delgado, C. F. Habeger, J. Mater. Res. 17 (2002) 1843, J. Hoard, SAE Technical Paper Series #2001-01-0185. SAE: Warrendale, Pa., 2001, and C. L. Aardahl, K. G. Rappe, P. W. Park, C. S. Ragle, C. L. Boyer, S. A. Faulkner SAE Technical Paper Series #2003-01-1186. SAE: Warrendale, Pa., 2003.

Plasma-facilitated catalysis is a two-step process consisting of plasma pretreatment of the exhaust before flow over a lean NOx catalyst. Hydrocarbon is added to the exhaust to enable specific oxidation chemistry in the plasma and subsequent NOx reduction chemistry over the catalyst. Oxidation of NO to NO₂ takes place in the first step. Although this is not a required characteristic on some catalysts, it does transform NOx to the more reactive NO₂ form, which has been demonstrated to enhance activity at lower temperatures due to the higher reactivity of the NO₂ versus NO. In the second stage, NOx is converted to N₂ over the catalyst while hydrocarbons are consumed. The plasma also partially oxidizes hydrocarbon, which is now recognized to be a source of critical intermediates for NOx reduction as described in B. M. Penetrante, R. M. Brusasco, B. T. Merrit, W. J. Pitz, G. E. Vogtlin, M. C. Kung, H. H. Kung, C. Z. Wan, K. E. Voss, SAE Technical Paper Series #982508. SAE: Warrendale, Pa., 1998, R. Dorai, M. J. Kushner, SAE Technical Paper Series #1999-01-3683. SAE: Warrendale, Pa., 1999, J. W. Hoard and A. Panov, SAE Technical Paper Series #2001-01-3512. SAE: Warrendale, Pa., 2001, A. G. Panov, R. G. Tonkyn, M. L. Balmer, C. H. F. Peden, A. Malkin, and J. W. Hoard, SAE Technical Paper Series #2001-01-3513. SAE: Warrendale, Pa., 2001, S. J. Schmieg, B. K. Cho, and S. H. Oh, SAE Technical Paper Series #2001-01-3565. SAE: Warrendale, Pa., 2001, S. E. Thomas, J. T. Shawcross, R. Gillespie, D. Raybone, A. R. Martin, SAE Technical Paper Series #2001-01-3568. SAE: Warrendale, Pa., 2001, and K. G. Rappe, C. L. Aardahl, C. F. Habeger, D. N. Tran, M. A. Delgado, L.-Q. Wang, P. W. Park, M. L. Balmer, SAE Technical Paper Series #2001-01-3570. SAE: Warrendale, Pa., 2001.

Another secondary benefit of the plasma is the oxidation NO and hydrocarbons without oxidizing SO₂ to SO₃, which allows a broad range of catalysts to be more resistant to typical aging concerns as shown in B. M. Penetrante, R. M. Brusasco, B. T. Merritt, W. J. Pitz, G. E. Vogtlin, SAE Technical Paper Series #1999-01-3687. SAE: Warrendale, Pa., 1999.

Using experiments and simulation, Penetrante and his colleagues conducted extensive studies on the gas phase chemistry in the plasma oxidation step which they described in B. M. Penetrante, R. M. Brusasco, B. T. Merrit, W. J. Pitz, G. E. Vogtlin, M. C. Kung, H. H. Kung, C. Z. Wan, K. E. Voss, SAE Technical Paper Series #982508. SAE: Warrendale, Pa., 1998 and B. M. Penetrante, R. M. Brusasco, B. T. Merritt, W. J. Pitz, G. E. Vogtlin SAE Technical Paper Series. Paper 1999-01-3637. SAE International: Warrendale, Pa., 1999. These findings indicated that plasma treatment of lean exhaust alone does not lead to efficient conversion to NO₂. In the absence of added hydrocarbon, O. is formed and converts NO₂ back to NO in simulated lean exhaust. Hydrocarbon serves as an O. sink, and byproducts of the O. consumption process include peroxyl radicals (RO₂., HO₂.). Peroxyl radicals allow conversion of NO to NO₂ without back reactions taking place. The second step in PFC involves active lean NOx catalysis, primarily with NO₂ and partially oxidized hydrocarbons. As noted above, plasma treatment of exhaust gases results in some degree of partial oxidation of the hydrocarbon reducing agent. Recent studies, such as those indicated above as well as D. N. Tran, C. L. Aardahl, K. G. Rappe, P. W. Park, C. L. Boyer, Appl. Catal. B, submitted, have shown that the nature of the hydrocarbon species can have a large impact on the thermal catalytic and plasma catalytic performance of lean NOx catalysts, and oxygenates in particular appear to be critical intermediates over many catalytic materials.

Several investigations have shown that the addition of alkali and alkaline earth cations (for zeolites) or transition metal ions (for γ-alumina) enhances catalytic activity. These include, but are not limited to F. C. Meunier, V. Zuzaniuk, J. P. Breen, M. Olsson, J. R. H. Ross, Catal. Today 59 (2000) 287, F. C. Meunier, V. Zuzaniuk, J. P. Breen, M. Olsson, J. R. H. Ross, J. Catal. 187 (1999) 493, T. Maunula, Y. Kintaichi, M. Inaba, M. Haneda, K. Sato, H. Hamada, Appl. Catal. B 15 (1998) 291, E. Seker, J. Cavataio, E. Gulari, P. Lorpongpaiboon, S. Osuwan, Appl. Catal. A 183 (1999) 121, A. Keshavaraja, X. She, M. Flytzani-Stephanopoulos, Appl. Catal. B 27 (2000) L1, S. Sumiya, M. Saito, M. Furuyama, N. Takezawa, K. Yoshida, React. Kinet. Catal. Lett. 64 (1998) 239, K. Shimizu, A. Satsuma, T. Hattori, Appl. Catal. B 16 (1998) 319, K. A. Bethke, H. H. Kung, J. Catal. 181 (1997) 93, M. C. Kung, P. W. Park, D.-W. Kim, H. H. Kung, J. Catal. 181 (1999) 1, T. Maunula, Y. Kintaichi, M. Haneda, H. Hamada, Catal. Lett. 61 (1999) 121, P. W. Park, C. S. Ragle, C. L. Boyer, M. L. Balmer, M. Engelhard, D. McCready, J. Catal. 210 (2002) 97, T. Maunula, J. Ahola, H. Hamada, Appl. Catal. B 26 (2000) 173, F. C. Meunier, R. Ukropec, C. Stapleton, J. R. H. Ross, Appl. Catal. B 30 (2001) 163, K. Shimizu, J. Shibata, H. Yoshida, A. Satsuma, T. Hattori, Appl. Catal. B 30 (2001) 151, and T. Chafik, S. Kameoka, Y. Ukisu, T. Miyadera, J. Molec. Catal. A 136 (1998) 203. Metals activate hydrocarbons and may provide sites for conversion of NOx and hydrocarbons to surface intermediates like organonitrile, isocynate, or formate species. Therefore, when plasma pretreatment of exhaust is combined with metal-promoted catalysis, there is an opportunity to take advantage of hydrocarbon activation through the plasma and over promoter sites on the catalyst. Recent PFC results on In-promoted γ-alumina catalysts and reported in D. N. Tran, C. L. Aardahl, K. G. Rappe, P. W. Park, C. L. Boyer, Appl. Catal. B, submitted, demonstrated that these two activation mechanisms must be balanced to maximize conversion.

Many catalyst formulations have been proposed and tested for lean NOx activity. For lower exhaust temperatures (<550K), Cu/ZSM-5 has shown interesting results, but Cu/ZSM-5 shows low durability at higher exhaust temperatures as reported in M. Sasaki, H. Hamada, Y. Kintaichi, T. Ito, Catal. Lett. 15 (1992) 297, R. A. Grinstedt, H.-W. Jen, C. N. Montreuil, M. J. Rokosz, M. Shelef, Zeolites 13 (1993) 602, and R. Keiski, H. Raisanen, M. Harkonen, T. Maunula, P. Niemisto, Catal. Today 26 (1996) 85. In plasma operation, the best success at low temperatures (423-543K) has been achieved using catalysts based on zeolite Y supports as shown in A. G. Panov, R. G. Tonkyn, M. L. Balmer, C. H. F. Peden, A. Malkin, and J. W. Hoard, SAE Technical Paper Series #2001-01-3513. SAE: Warrendale, Pa., 2001. For higher temperatures (>573K) catalysts based on γ-alumina have shown the most promise because of their durability at higher temperatures and high thermal activity, particularly when reaction temperatures approach 673K.

The temperature ranges for light duty and heavy-duty diesel exhaust overlap in the 473-623K range. In general, the zeolite Y catalysts do not deliver appreciable activity at the high end of the light duty range, and the γ-alumina catalysts are insufficient at the low end of the heavy-duty range. The overlap in the activity ranges occurs where NOx reduction activity transitions from zeolite Y to γ-alumina materials. Therefore, it is not surprising that mixtures of catalysts have been used to broaden the active temperature window for both light duty and heavy-duty applications. The first report of such an approach was made by Panov and coworkers as reported in A. G. Panov, R. G. Tonkyn, M. L. Balmer, C. H. F. Peden, A. Malkin, and J. W. Hoard, SAE Technical Paper Series #2001-01-3513. SAE: Warrendale, Pa., 2001. Other reports such as J. Bonadies, “Performance Evaluation of the Delphi Non-Thermal Plasma System Under Transient and Steady-State Conditions” presentation given at the 8^{th} Diesel Engine Emissions Reduction Conference, US DOE FreedomCAR and Vehicle Technologies, San Diego, Calif., Aug. 25-29, 2002. In this paper, the catalyst combination Ba/zeolite Y and Ag/γ-alumina is examined under steady and transient operation.

Despite these and other advances, no one has yet successfully demonstrated the complete elimination of NOₓ. Until someone does, there will remain a need for new techniques, methods and apparatus that achieve greater reductions in NOₓ than those previously reported, and any technique, method or apparatus that achieves greater reductions than those previously shown will redefine the current state of the art. The present invention described herein does exactly that.

### BRIEF SUMMARY OF THE INVENTION

Briefly, the present invention has been demonstrated to achieve greater reductions in NOₓ than have previously been reported in gasses which are designed to simulate the emissions of an internal combustion engine across a normal operating range. While the present invention was developed as a solution to the problems associated with NOₓ emissions in internal combustion engines, as will be readily apparent to any having ordinary skill in the art, the present invention is equally applicable to the reduction of NOₓ from any source, and, as such, while the present invention will likely find its greatest utility in treating the exhaust gas from internal combustion engines, the present invention should in no way be viewed as limited to such exhaust gases. Rather, the present invention should be broadly construed to encompass the treatment of a gas stream containing NOₓ from any source.

Generally, the method of the present invention reduces NOₓ in a gas stream by sequentially exposing the gas stream to a first and a second catalyst. The first catalyst accomplishes several functions. It converts at least a portion of the gas stream to a reducing gas, it reduces at least a portion of the NOₓ in a first temperature range, and it absorbs at least a portion of the NOₓ in the first temperature range. The second catalyst reduces at least a portion of the NOₓ in a second temperature range utilizing the reducing gas produced by the second catalyst. While the first and second temperature ranges are tailored to the specific catalysts selected, for most suitable catalysts the first temperature range extends to up to about 500 degrees K, and the second temperature range is between about 450 degrees K up to about 800 degrees K. As is shown in the example set forth in the detailed description below, this technique enables the method of the present invention to achieve greater total reductions in NOₓ across the typical operating temperatures of an internal combustion engine than have previously been reported.

The reducing gas produced by the first catalyst is typically a partially oxidized hydrocarbon, preferably an aldehyde, and more preferably acetaldehyde and formaldehyde. In addition to the first and second catalysts, the gas stream may be exposed to a plasma. This may occur prior to the step of exposing the gas stream to the first catalyst, simultaneous with exposing the gas stream to the first catalyst, simultaneous with the step of exposing the gas stream to the second catalyst, or simultaneous with both of the steps of exposing the gas stream to the first and second catalyst.

Preferably, the first catalyst is selected as a zeolite, and more preferably a zeolite impregnated with an cation. The cation is preferably selected from the group consisting of an alkaline cation, an alkaline earth cation, and combinations thereof. The first catalyst preferably exhibits pores sizes of greater than 4 angstroms, and more preferably exhibits pores sizes of greater than 7 angstroms. As described in the preferred embodiment set forth below, the first catalyst is selected as barium/zeolite Y (BaZY), and more specifically barium/zeolite Y (BaZY) prepared via solution ion exchange of Ba²⁺ on sodium/zeolite Y (NaZY). The second catalyst is preferably a γ-alumina catalyst, and more preferably a γ-alumina catalyst is impregnated with transition metals, including, but not limited to, Ag, In and Sn. Also as described in the preferred embodiment set forth below, the second catalyst is selected as Ag/γ-alumina catalyst doped with Ag on γ-Al₂O₃. Preferably, the Ag/γ-alumina catalyst is doped with between 8 and 0.1 wt % Ag on γ-Al₂O₃, and more preferably between 3 and 0.5 wt % Ag on γ-Al₂O₃.

### BRIEF DESCRIPTION OF THE SEVERAL VIEWS OF THE DRAWING

FIG. 1. is a schematic drawing of the exhaust treatment test stand used for steady-state PFC measurements in experiments designed to demonstrate a preferred embodiment of the present invention.

FIG. 2. is a graph showing steady-state performance of individual catalysts in experiments designed to demonstrate a preferred embodiment of the present invention.

FIG. 3. is a graph showing effluent NOx species after PFC treatement with BaZY catalyst. The ‘transient’ gas mixture at a flow rate of 4 SLM was used with 6 g catalyst. Arrows indicate the direction of increasing temperature in the ‘transient’ loop.

FIG. 4. is a graph showing effluent NOx species after PFC treatement with Ag/Al₂O₃ catalyst. The ‘transient’ gas mixture at a flow rate of 4 SLM was used with 6 g catalyst. Arrows indicate the direction of increasing temperature in the ‘transient’ loop.

FIG. 5. is a graph showing ‘steady-state’ NOx conversion for 3 cases where mixed catalysts were used. “Mixed” indicates a homogeneous mixture of powders. A→Z indicates alumina preceding zeolite, and Z→A indicates zeolite preceding alumina. In all cases, a ‘steady-state’ gas mixture at a flow rate of 1 SLM was used. 1 g of each catalyst (2 g total) was loaded into the reactor for these tests.

FIG. 6. is a graph showing effluent NOx species after PFC treatment with the Z→A catalyst configuration. The ‘transient’ gas mixture at a flow rate of 4 SLM was used with 6 g BaZY followed by 3 g Ag/Al₂O₃. Arrows indicate the direction of increasing temperature in the ‘transient’ loop.

FIG. 7. is a graph showing acetaldehyde levels observed in transient testing with individual catalysts and the optimal configuration.

FIG. 8. is a graph showing formaldehyde levels observed in transient testing with individual catalysts and the optimal configuration.

FIG. 9. is a graph showing ‘transient’ NOx conversion for the Z→A configuration. The ‘transient’ gas mixture at a flow rate of 4 SLM was used with 6 g BaZY followed by 3 g Ag/Al₂O₃. Arrows indicate the direction of increasing temperature in the ‘transient’ loop.

### DETAILED DESCRIPTION OF THE INVENTION

A series of experiments were conducted to show the operation of a preferred embodiment of the present invention, and to demonstrate that the present invention achieves a reduction of NOₓ heretofore unobtainable by methods, techniques, and apparatus described in the prior art. While the specific catalysts Ba/zeolite Y and Ag/γ-alumina were selected to demonstrate this preferred embodiment, the present invention should in no way be viewed as limited to these specific catalysts. Instead, as will be recognized by those having skill in the art, the specific catalysts should be viewed as providing just one example for achieving the desired reactions described more generally in the Summary of the Invention and set forth in the attached claims. Other catalysts known to produce the same reaction products as the catalysts used in the examples set forth below could readily be substituted, and those having skill in the art would expect such substitutions to operate in the same way, for the same purpose, and with the same expected results, as the catalysts described herein.

A series of experiments examining the catalyst combination Ba/zeolite Y and Ag/γ-alumina were conducted to examine the reduction of NOₓ under steady and transient operation. These experiments demonstrated that placing BaZY upstream of Ag/Al₂O₃ enhanced the NOx reduction activity over the BaZY or Ag/Al₂O₃ catalysts used individually. The higher activity is due to significant formation of formaldehyde over BaZY that was effectively used as a reducing agent over Ag/Al₂O₃. Under steady operation conversion ranged from 80 to in excess of 95%, and under ‘transient’ operation a cycle average of 70% reduction was achieved. The drop in efficiency in cycled operation is attributed to NOx desorption during heating ‘transients’ below 473K. An optimal configuration will be especially beneficial during realistic temperature transients due to the fact that during NOx desorption, the downstream catalyst may be reaching temperatures where it is active, resulting in partial conversion of the desorbed NOx. It should also be possible to control the hydrocarbon levels in a manner that alleviates the pulses of NOx that evolve during catalyst heating.

The Ag/γ-alumina catalyst tested under ‘steady-state’ conditions was doped with 0.95 wt % Ag on γ-Al₂O₃. The γ-Al₂O₃ support (Puralox, Condea Vista) had a BET surface area of 145 m²/g. Silver impregnation was achieved using the incipient wetness technique with a solution of AgNO₃. The impregnated samples were dried in air at 373K for 24 hr and calcined by ramping at 30 K/hr to 1023K, holding for 30 minutes, and ramping down at 300 K/hr.

The γ-alumina support (surface area 230 m²/g) used in the ‘transient’ experiments was prepared by a sol-gel method using alumina isopropoxide and 2-methyl-2,4-pentanediol as a complexing agent. The procedure for the alumina preparation has been described in P. W. Park, H. H. Kung, D.-W. Kim, M. C. Kung, J. Catal. 184 (1999) 440. A 4 wt % Ag/Al₂O₃ catalyst was prepared using the incipient wetness technique with γ-alumina powder and an aqueous solution of silver nitrate. Here, higher silver loading on the catalyst was better for the higher sulfur levels used in the ‘transient’ test conditions described below. The impregnated samples were dried in air at 373K for 24 hr and calcined at temperatures up to 873K (ramp rate: 1.2K/min) for 5 hr under flowing air at 5 SLM.

The barium/zeolite Y (BaZY) catalyst used in the ‘steady-state’ and ‘transient’ experiments was prepared via solution ion exchange of Ba²⁺ on sodium/zeolite Y (NAZY) powder (CBV100, Zeolyst International). A Ba(NO₃)₂ aqueous solution was mixed with NaZY powder at a ratio of 0.614 grams Ba per gram NaZY powder. The resultant product was centrifuged, decanted, recovered, and a second Ba(NO₃)₂ aqueous solution added. When complete, that product was recovered in the same manner (with additional rinsing with DI water & centrifuging) and dried in a vestibule in a drying oven at 323K for 1 to 2 hours. The product was then calcined at 773K for 2 hours at a thermal ramp of 10 K/min.

A feed gas composed of 260 ppm NO, 5 ppm NO₂, 0 or 50 ppm SO₂, 7% CO₂, 7% O₂, 1% Ar, 400 ppm CO, 133 ppm H₂, 500 ppm C₃H₆, 133 ppm C₃H₈, 2.8% H₂O, and a balance of N₂ was used for the transient tests. The dry gases were mixed and passed over a heated wick, where water was added, thereby humidifying the gas while avoiding pulsation effects due to direct pumping. The resulting humidified gas was fed via heated stainless steel lines to a test stand consisting of two ovens in series.

The first oven housed a parallel-plate dielectric-barrier discharge device with embedded electrodes, operated at a space velocity of 150,000 hr⁻¹. The reactor was powered by a Trek Model 10/10, driven by a HP 33120A function generator. Power was measured using a Tektronix TDS420A oscilloscope that received signals from a Tektronix P6015A high-voltage probe and a 1 kΩ current sense resistor in series with the reactor. Power was held constant at 30 J/L via a Labview program running a PID control algorithm, where power regulation is adjusted by changes in AC frequency. The second oven housed a quartz tube containing the catalyst(s) of interest. Both ovens were equipped with cooling air and were programmable for thermal cycling.

The 4 L/min flow of test gas was diluted 5:1 with nitrogen following the second oven to avoid water condensation at room temperature, resulting in 20 L/min through the analytical instruments. Primary analyses were performed with a Mattson Nova Cygni 120 Fourier Transform Infrared (FTIR) Analyzer (0.25 wavenumber resolution) equipped with a Foxboro 21.75-meter gas cell. Conventional Horiba emission analyzers included IR for CO & CO₂, flame ionization for total hydrocarbons, magneto-pneumatic for O₂, and chemiluminescence for NOx.

Thermal cycling was performed between 373 and 773K with a ramp rate of 10K/min. At each end of the ramp, the minimum or maximum temperature was held for 12 minutes prior to heating or cooling, respectively. For all transient results reported herein, the data shown are for the final cycle on the material. The final cycle was determined by waiting until two consecutive cycles overlapped, which typically occurred in 3 to 4 loops. Taking the data during consistent loops insured that the material had reached a quasi-steady condition where loading and desorption of the catalyst over the cycle occurred to the same extent. The transient cycling used herein was performed in order to understand how the material behaves during thermal cycling, as opposed to any established transient testing protocols.

A feed gas consisting of 500 ppm NO, 300 ppm CO, 8% CO₂, 1.5% H₂O, 2 ppm SO₂, 9% O₂ , 2000 ppm C₃H₆, and balance of N₂ was used for the steady-state testing. NO, CO, CO₂, SO₂, O₂, and hydrocarbon were mixed together as dry gases and combined with a humid N₂ stream to achieve 1 L/min total simulated exhaust. Gases are mixed and carried to the PFC system using room temperature PTFE lines. The humidified stream is sent to a two-stage high-temperature apparatus consisting of a pair of tubular furnaces. The first furnace housed a high-temperature plasma reactor, and the second furnace housed the catalysts of interest.

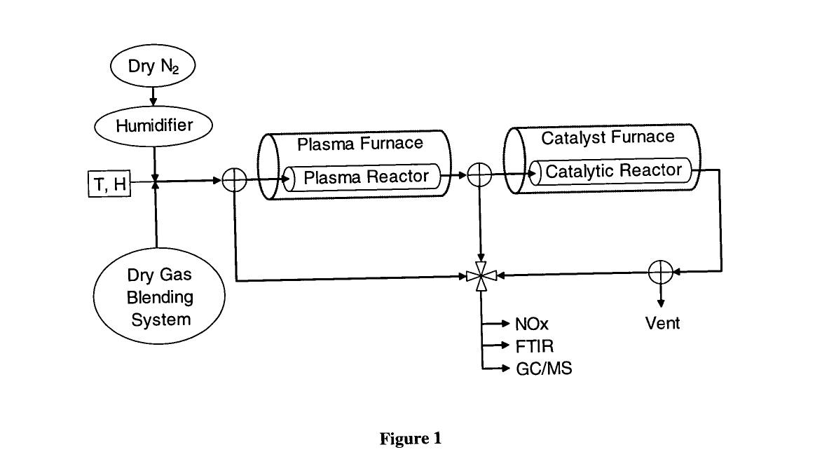

The apparatus employed for steady-state measurements is shown in FIG. 1. Three gas sampling locations were used: pre-plasma, post-plasma, and post-catalyst. The sample ports were connected to a three-position valve, which routed the entire flow through a nafion-tube diffusion dryer (Mini-GASS, Perma Pure, Inc.) prior to transfer to the analytical systems. Analytical capabilities included a Rosemount 951A Chemiluminescence NO/NOx Analyzer and a Nicolet 210 FTIR spectrometer with a 10-meter path length for measurement of IR active species. Measurements shown here were acquired with the chemiluminescence analyzer, and FTIR measurements were used to show accurate calibration of the analyzer.

The concentric cylinder plasma reactor was the first stage of the apparatus. The reactor was formed using a ½-inch OD alumina tube inside of a 1-inch OD alumina tube. A section of the ½-inch tube was packed with stainless steel wool, forming the high-voltage electrode, and the corresponding section of the 1-inch tube was sheathed by stainless steel mesh, forming the ground electrode. A non-thermal dielectric discharge was formed in the annulus between the two tubes. 1 L/min of simulated exhaust stream flowed through this region at a space velocity of ˜4000 hr⁻¹. The high-voltage electrode was electrified using 3 to 9 kV(rms) from a Corona Magnetics high voltage transformer. The transformer was powered by an audio amplifier (RMX1450, QSC), which in turn was driven by a waveform generator (3011B, BK Precision). Typical operating frequency was in the range of 100-400 Hz. A 1000:1 high-voltage probe monitored the voltage supplied to the high-voltage electrode, and the ground current was sent through a 2 μF capacitor to monitor the plasma discharge current. After conditioning, these two signals are monitored by a Lecroy 9420 dual oscilloscope and power is calculated via a Visual Basic program that determines the area of the voltage versus current curve acquired from the oscilloscope described in L. A. Rosenthal, D. A. Davis, IEEE Trans. Ind. Appl. I-5 (1975) 328. Energy density deposited in the gas ranged from 0 to 150 J/L. A catalytic reactor made up the second stage of the apparatus. The reactor consisted of a 1-inch OD quartz tube with a bed of catalyst powder held in place by quartz wool. Typical catalyst loadings were 1 to 2 g. Space velocities ranged from 14,000 hr⁻¹ to 29,000 hr⁻¹, depending on test configuration and bulk density of the powders used.

The temperature of each stage was controlled independently via the tube furnaces housing each reactor. Each catalyst configuration was examined at 473, 623, & 773K, with the plasma and catalyst reactors held at the same temperature. This allowed plasma-assisted catalyst activity to be examined over the range of interest for heavy-duty diesel exhaust, representing idle, road, and high-load conditions for the engine. The low end of this range also represents conditions of interest for light duty applications.

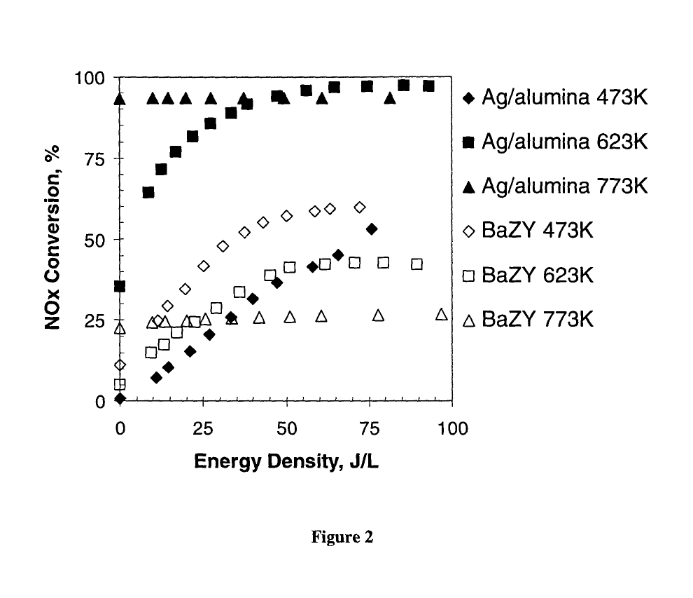

The BaZY catalyst and Ag/Al₂O₃ catalyst were tested independently using 1 gram of catalyst and the steady-state test mixture with propene as the reducing agent. FIG. 2 shows these isothermal test results at 473, 623, and 773K. The shapes of the curves are typical for PFC data sets. Typically, lower temperature data show a sharp rise in conversion as specific energy deposition increases, which is a result of formation of oxygenated hydrocarbons and NO₂ in the plasma leading to higher conversion rates over the catalyst. At high temperature, the plasma does not show benefit due to the high thermal activity of the catalyst. From FIG. 2, BaZY demonstrates consistently higher activity than Ag/Al₂O₃ at 473K, with roughly double the activity at ˜50 J/L. With higher temperatures the BaZY activity dropped, whereas the Ag/Al₂O₃ catalyst demonstrates significantly higher activity, reaching 97% NOx conversion at 623K and 94% conversion at 773K, in comparison to 43% and 27% for the BaZY, respectively. This is an expected result based on previous investigation of each of these materials. Panov & colleagues showed BaZY catalyst activity over the temperature range of 423 to 573K, with conversion decreasing significantly at higher temperatures in A. G. Panov, R. G. Tonkyn, M. L. Balmer, C. H. F. Peden, A. Malkin, and J. W. Hoard, SAE Technical Paper Series #2001-01-3513. SAE: Warrendale, Pa., 2001. Alumina-based catalysts have been studied extensively for higher temperature operation. Doping of the catalyst with Ag leads to better activity at lower temperatures (623K) than γ-alumina itself. However, hydrocarbon consumption becomes a significant factor at 773K due to activation by the silver sites, which is believed to be the reason greater NOx conversion is achieved at 623K compared to 773K.

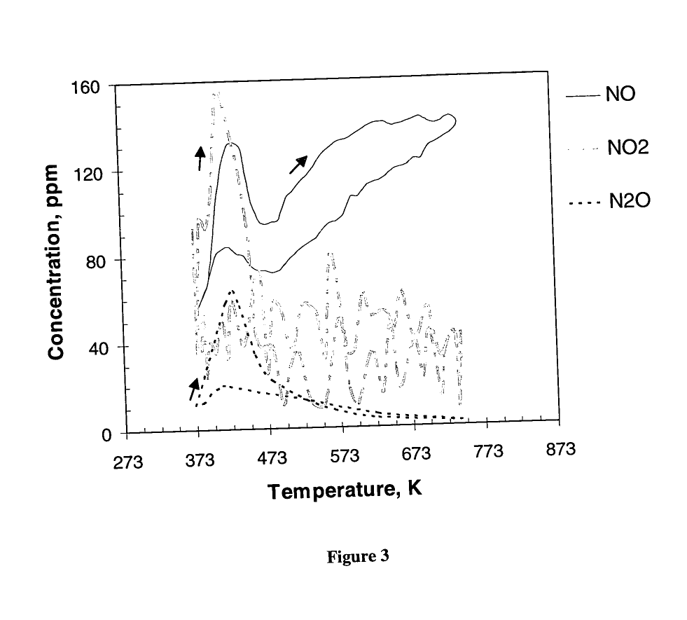

Results from transient testing on BaZY are shown in FIG. 3. Here, 6 grams of catalyst were used. Arrows indicate the direction of the loop for the temperature transient. The data in FIG. 3 confirm that BaZY activity peaks at 473K and decreases at higher temperatures. An important feature here is the hump observed in NO and NO₂ levels around 423K. Such behavior indicates NOx storage on the catalyst at lower temperatures. Cycling up in temperature results in thermal desorption and a resulting increase in NOx levels. The data also indicate that in the active temperature regime some N₂O is formed over BaZY, which is consistent with the results reported in J. W. Hoard and A. Panov, SAE Technical Paper Series #2001-01-3512. SAE: Warrendale, Pa., 2001.

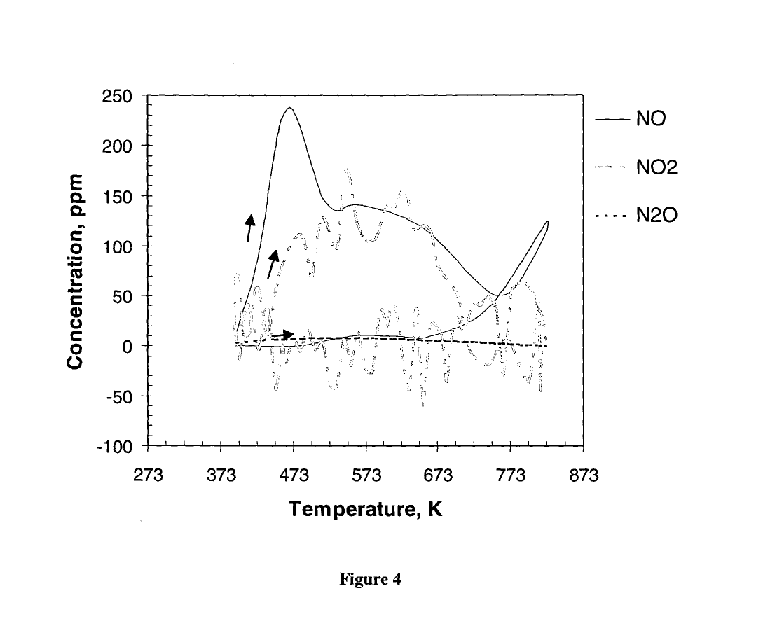

Results from transient testing on Ag/Al₂O₃ are shown in FIG. 4. Again, 6 g of catalyst was used. There is no evidence of N₂O formation on this catalyst, and the NOx traces have many features seen in the BaZY data. Storage of NO is greater on this catalyst than for BaZY, and the affinity for NO to the surface is slightly higher, which is indicated by the shift in desorption peak to somewhat higher temperature. The NO₂ storage is subtle and does not display a sharp peak as in the BaZY case. NOx levels on the Ag/Al₂O₃ drop precipitously above 573K with maximum conversion occurring at ˜748K. Above this temperature hydrocarbon combustion over the catalyst starts to dominate and limits availability of reductants for NOx conversion.

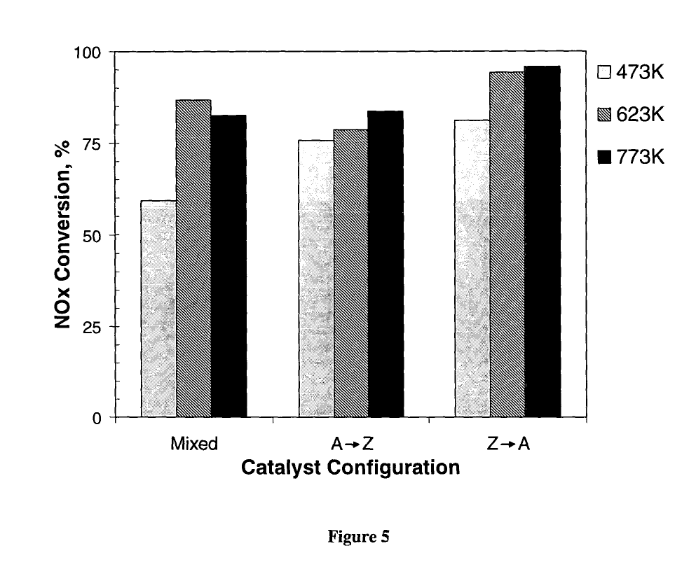

FIG. 5 shows the test results where BaZY and Ag/Al₂O₃ were tested together under ‘steady-state’ reaction conditions. Three testing configurations were examined: (i) powders completely mixed, (ii) Ag/Al₂O₃ followed by BaZY, and (iii) BaZY followed by Ag/Al₂O₃. In each case the 2 g catalyst bed was composed of equal weights of each catalyst, and all data were taken at 50 J/L. It is clear from examination of the data that proper staging of the catalysts is critical to obtaining maximum conversion. In particular, configuration (iii) shows consistently higher NOx conversion results for all temperatures examined. Over 95% efficiency at 623 and 773K, and over 80% conversion at 473K were obtained. This is an important result in that such high NOx conversion efficiencies have not been previously demonstrated over such a wide range of temperature.

Comparison of these data to the results obtained with the individual catalysts is not straightforward because of the different amounts of catalyst used. The space velocity was held constant in each of the experiments for a given catalyst, but in the dual catalyst experiments the overall space velocity is half that of the single catalyst experiments. Activity over a broader temperature range is certainly evident; therefore, it seems as though the specific desirable characteristics of each catalyst contribute to overall reactivity in their respective temperature regimes. However, the reason for improved performance when the catalysts are sequenced with BaZY before Ag/Al₂O₃ cannot be understood from the NOx conversion data alone. In order to better understand why this specific catalyst ordering is important, NOx reduction performance and the speciation of the hydrocarbons were examined using ‘transient’ experiments.

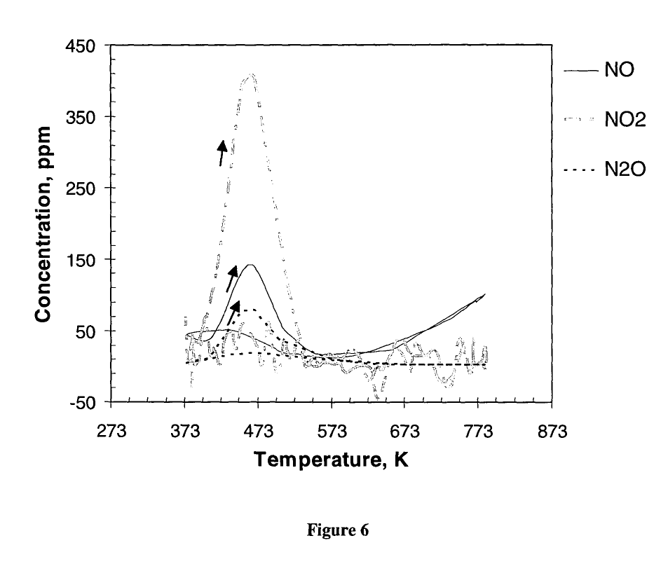

FIG. 6 shows effluent NOx concentrations from the optimal dual catalyst system under transient conditions. Here, 6 g of BaZY preceded 3 g of Ag/Al₂O₃. The data show that low temperature storage is still a concern; however, overall NOx levels are lower when compared to the single catalysts, and the temperature where maximum efficiency is observed (˜300K) shifts to the point where the activity of both catalysts overlap substantially. Also of interest is the larger NO₂ desorption peak; in fact, compared to the single catalyst data, the amount of adsorbed NO₂ increases substantially. It is possible that intermediates formed on the BaZY allow more efficient storage of NO₂ on Ag/Al₂O₃. This is supported by the data in FIG. 3 that show the predominant form of NOx discharged from BaZY is NO₂ at low temperature. The fact that the mean desorption temperature for NO₂ on the dual catalyst configuration is near 473K also supports the theory of NO₂ storage on Ag/Al₂O₃ at low temperature because that desorption temperature is consistent with what was observed on the Ag/Al₂O₃ alone. It is also conceivable that NOx stores on the zeolite and a portion is desorbed and shifted to the alumina as the temperature increases between 423 and 473K.

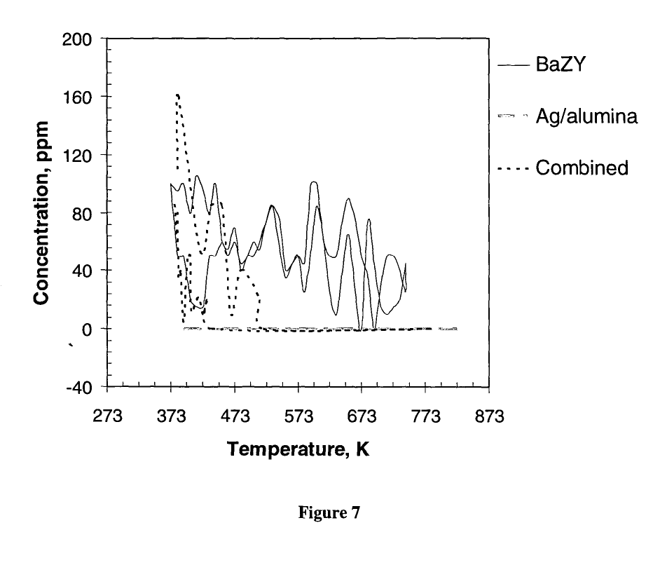

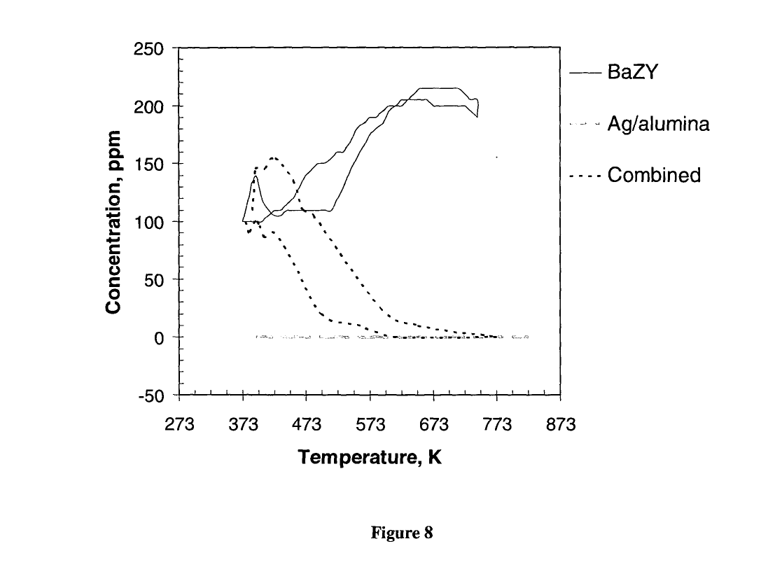

Additional information on the dual catalyst system can be obtained by following the fate of the partially oxidized hydrocarbon intermediates that are formed in the plasma reactor over each of the catalysts alone and in their optimum dual catalyst configuration. FIGS. 7 and 8 show the acetaldehyde and formaldehyde levels, respectively, for each of the cases. FIG. 7 shows that there are no appreciable acetaldehyde levels following the Ag/Al₂O₃ alone. However, in both cases where the BaZY is present, noticeable levels of acetaldehyde exit the reactor. For BaZY alone, acetaldehyde utilization increases slightly as temperature increases. For the Z→A dual catalyst configuration, acetaldehyde levels fall to zero at temperatures above 473K.

FIG. 8 shows that formaldehyde levels actually increase over the temperature range examined following a BaZY catalyst alone. This is consistent with previous reports by Panov and colleagues who showed that formaldehyde is inactive for NOx reduction over BaZY in A. G. Panov, R. Tonkyn, S. Yoon, A. Kolwaite, S. Barlow, and M. L. Balmer, NOx Reduction Behavior of Alumina and Zeolite Catalysts in Combination with Non-Thermal Plasma, presentation given at the 6^{th} Diesel Engine Emissions Reduction Workshop, US DOE FreedomCAR and Vehicle Technologies, San Diego, Calif., August 2000. In fact, the increasing levels indicate that formaldehyde is formed over the BaZY catalyst at higher temperatures. As also seen for acetaldehyde, formaldehyde is consumed to nearly completion following the dual catalyst formulation indicating that Ag/Al₂O₃ utilizes both of these species to accomplish NOx reduction. S. E. Thomas, J. T. Shawcross, R. Gillespie, D. Raybone, A. R. Martin, SAE Technical Paper Series #2001-01-3568. SAE: Warrendale, Pa., 2001 showed that formaldehyde was an excellent reducing agent for use with Ag/Al₂O₃, so it is reasonable to assume that production of formaldehyde by BaZY is the critical aspect that makes this particular configuration perform so well for NOx reduction. An added benefit of the configuration is the lower hydrocarbon slip due to high utilization of the hydrocarbon.

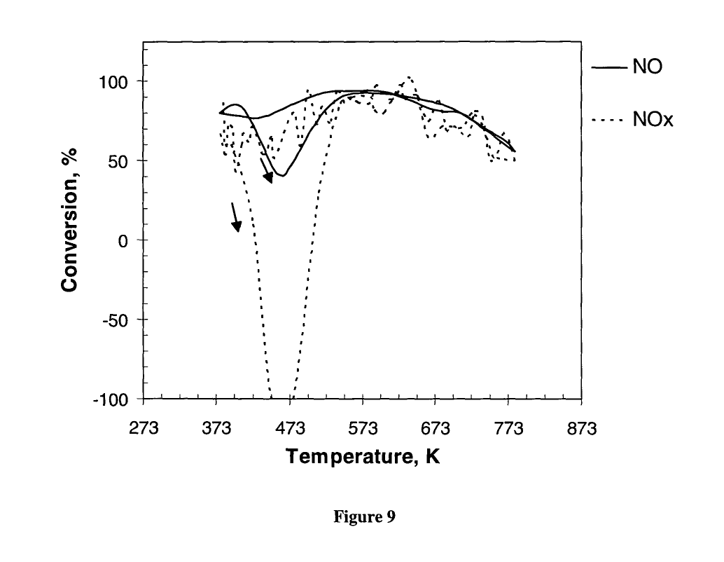

FIG. 5 shows the NOx efficiency under ‘steady-state’ reaction conditions. This represents the highest activity ever reported over such a broad temperature range. The performance under ‘transient’ conditions is also of interest. FIG. 9 shows the NOx conversion plot for the ‘transient’ case. For most of the cycle the conversion is quite high at 60-95%; however, the desorption of NO₂ on the heating ramp from low temperature detracts significantly from the overall NOx conversion for a cycle. Even with the large degree of NO₂ desorption, the overall NOx reduction for the cycle is still around 70%. This represents the highest level reported in such an experiment, and a significantly higher level than in the single catalyst cases examined here. It is expected that management of the hydrocarbon levels (eg., inject more hydrocarbon during engine load increases) during realistic vehicle exhaust temperature transients could result in better control of overall NOx conversion, especially by reducing the deleterious effects of NOx desorption during temperature spikes.

### Closure

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

1) a method for reducing NOₓ in a gas stream comprising the steps of sequentially exposing said gas stream to a first catalyst and a second catalyst wherein said first catalyst:
a. converts at least a portion of said gas stream to a reducing gas,
b. reduces at least a portion of said NOₓ in a first temperature range, and
c. absorbs at least a portion of said NOₓ in said first temperature range, and wherein said second catalyst
d. reduces at least a portion of said NOₓ in a second temperature range utilizing said reducing gas.

2) The method of claim 1 wherein said reducing gas is selected as a partially oxidized hydrocarbon.

3) The method of claim 1 wherein said reducing gas is selected as an aldehyde.

4) The method of claim 3 wherein said aldehyde is selected from the group consisting of acetaldehyde and formaldehyde.

5) The method of claim 1 wherein said gas stream is exposed to a plasma prior to the step of exposing said gas stream to said first catalyst.

6) The method of claim 1 wherein said gas stream is exposed to a plasma simultaneous with the step of exposing said gas stream to said first catalyst.

7) The method of claim 1 wherein said gas stream is exposed to a plasma simultaneous with the step of exposing said gas stream to said second catalyst.

8) The method of claim 1 wherein said gas stream is exposed to a plasma simultaneous with the steps of exposing said gas stream to said first catalyst and said second catalyst.

9) The method of claim 1 wherein said first catalyst is selected as a zeolite.

10) The method of claim 9 wherein said first catalyst is selected as a zeolite impregnated with an cation.

11) The method of claim 10 wherein said cation is selected from the group consisting of an alkaline cation, an alkaline earth cation, and combinations thereof.

12) The method of claim 1 wherein said first catalyst exhibits pores sizes of greater than 4 angstroms.

13) The method of claim 1 wherein said first catalyst exhibits pores sizes of greater than 7 angstroms.

14) The method of claim 1 wherein said first catalyst is selected as barium/zeolite Y (BaZY).

15) The method of claim 1 wherein said first catalyst is selected as barium/zeolite Y (BaZY) prepared via solution ion exchange of Ba²⁺ on sodium/zeolite Y (NaZY).

16) The method of claim 1 wherein said second catalyst is selected as a γ-alumina catalyst.

17) The method of claim 16 wherein said γ-alumina catalyst is impregnated with ions selected from the group consisting of transition metals.

18) The method of claim 17 wherein said transition metal is selected from the group consisting of Ag, In and Sn.

19) The method of claim 1 wherein said second catalyst is selected as Ag/γ-alumina catalyst doped with between 8 and 0.1 wt % Ag on γ-Al₂O₃.

20) The method of claim 1 wherein said second catalyst is selected as Ag/γ-alumina catalyst doped with between 3 and 0.5 wt % Ag on γ-Al₂O₃.

21) A method for reducing NOₓ in a gas stream comprising the steps of sequentially exposing said gas stream to a first catalyst and a second catalyst wherein said first catalyst:
a. converts at least a portion of said gas stream to a reducing gas,
b. reduces at least a portion of said NOₓ in a first temperature range of up to about 500 degrees K, and
c. absorbs at least a portion of said NOₓ in said first temperature range, and wherein said second catalyst
d. reduces at least a portion of said NOₓ in a second temperature range of between about 450 degrees K to about 800 degrees K utilizing said reducing gas.

22) The method of claim 21 wherein said reducing gas is selected as a partially oxidized hydrocarbon.

23) The method of claim 21 wherein said reducing gas is selected as an aldehyde.

24) The method of claim 23 wherein said aldehyde is selected from the group consisting of acetaldehyde and formaldehyde.

25) The method of claim 21 wherein said gas stream is exposed to a plasma prior to the step of exposing said gas stream to said first catalyst.

26) The method of claim 21 wherein said gas stream is exposed to a plasma simultaneous with the step of exposing said gas stream to said first catalyst.

27) The method of claim 21 wherein said gas stream is exposed to a plasma simultaneous with the step of exposing said gas stream to said second catalyst.

28) The method of claim 21 wherein said gas stream is exposed to a plasma simultaneous with the steps of exposing said gas stream to said first catalyst and said second catalyst.

29) The method of claim 21 wherein said first catalyst is selected as a zeolite.

30) The method of claim 29 wherein said first catalyst is selected as a zeolite impregnated with an cation.

31) The method of claim 30 wherein said cation is selected from the group consisting of an alkaline cation, an alkaline earth cation, and combinations thereof.

32) The method of claim 21 wherein said first catalyst exhibits pores sizes of greater than 4 angstroms.

33) The method of claim 21 wherein said first catalyst exhibits pores sizes of greater than 7 angstroms.

34) The method of claim 21 wherein said first catalyst is selected as barium/zeolite Y (BaZY).

35) The method of claim 21 wherein said first catalyst is selected as barium/zeolite Y (BaZY) prepared via solution ion exchange of Ba²⁺ on sodium/zeolite Y (NaZY).

36) The method of claim 21 wherein said second catalyst is selected as a γ-alumina catalyst.

37) The method of claim 36 wherein said γ-alumina catalyst is impregnated with ions selected from the group consisting of transition metals.

38) The method of claim 37 wherein said transition metal is selected from the group consisting of Ag, In and Sn.

39) The method of claim 21 wherein said second catalyst is selected as Ag/γ-alumina catalyst doped with between 8 and 0.1 wt % Ag on γ-Al₂O₃.

40) The method of claim 21 wherein said second catalyst is selected as Ag/γ-alumina catalyst doped with between 3 and 0.5 wt % Ag on γ-Al₂O₃.

41) A method for reducing NOₓ in a gas stream comprising the steps of sequentially exposing said gas stream to a first catalyst consisting of barium/zeolite Y (BaZY) having pores sizes of greater than 7 angstroms and a second catalyst consisting of Ag/γ-alumina catalyst doped with between 3 and 0.5 wt % Ag on γ-Al₂O₃ wherein said first catalyst:
a. converts at least a portion of said gas stream to a reducing gas,
b. reduces at least a portion of said NOₓ in a first temperature range, and
c. absorbs at least a portion of said NOₓ in said first temperature range, and wherein said second catalyst
d. reduces at least a portion of said NOₓ in a second temperature range utilizing said reducing gas.

42) The method of claim 41 wherein said reducing gas is selected as a partially oxidized hydrocarbon.

43) The method of claim 41 wherein said reducing gas is selected as an aldehyde.

44) The method of claim 43 wherein said aldehyde is selected from the group consisting of acetaldehyde and formaldehyde.

45) The method of claim 41 wherein said gas stream is exposed to a plasma prior to the step of exposing said gas stream to said first catalyst.

46) The method of claim 41 wherein said gas stream is exposed to a plasma simultaneous with the step of exposing said gas stream to said first catalyst.

47) The method of claim 41 wherein said gas stream is exposed to a plasma simultaneous with the step of exposing said gas stream to said second catalyst.

48) The method of claim 41 wherein said gas stream is exposed to a plasma simultaneous with the steps of exposing said gas stream to said first catalyst and said second catalyst.

49) The method of claim 41 wherein said first catalyst is selected as barium/zeolite Y (BaZY) prepared via solution ion exchange of Ba₂₊ on sodium/zeolite Y (NaZY).
